(19) United States
(12) Patent Application Publication
(10) Pub. No.: US 2007/0249755 A1
(43) Pub. Date: Oct. 25, 2007

(54) Thermally Conductive Composition

(75) Inventors: Yuji Hiroshige, Tokyo (JP); Toshihiro Kasai, Kanagawa (JP); Yoshinao Yamazaki, Kanagawa (JP); Kiyoshi Tadokoro, Kanagawa (JP)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, ST. PAUL, MINNESOTA (PA)

(21) Appl. No.: 11/570,462

(22) PCT Filed: Jul. 12, 2005
(86) PCT No.: PCT/US05/24732

§ 371 Date: Dec. 12, 2006

(30) Foreign Application Priority Data
Jul. 27, 2004 (JP) 2004-219054

(51) Int. Cl. C08K 3/08; C08K 9/02

(52) U.S. Cl. 523/204

(57) ABSTRACT

There is provided a thermally conductive composition including: a thermally conductive filler, and a binder component. The thermally conductive filler includes: a particulate central portion comprising metal aluminum, and an electrically-insulated oxide layer having an average thickness of 500 nm or more formed on a surface of said central portion. The thermally conductive composition is capable of giving a thermally conductive sheet which has high thermal conductivity, which may not cause a problem such as a short circuit even if it is disposed in an integrated circuit (IC), or the like, and which has superior reliability.

### FIELD

The present invention relates to a thermally conductive composition. More specifically, the present invention relates to a thermally conductive composition which has high thermal conductivity and superior reliability.

### BACKGROUND

A thermally conductive sheet is generally disposed between a radiating body such as a heat sink and a heat-generating part for electronics or electronic parts including an integrated circuit (IC) so as to effectively transfer heat radiated from the heat-generating part to the side of the radiating body. In recent years, an amount of heat radiated from electronics has been increasing. Therefore, it is required to further improve thermal conductivity of the thermally conductive sheet and a thermally conductive composition which is a material for constituting the thermally conductive sheet.

In order to further enhance thermal conductivity of the thermally conductive composition, it is necessary to incorporate a filler having higher thermal conductivity in the thermally conductive composition. Examples of the thermally conductive filler include ceramics fillers such as alumina, silicon carbide, boron nitride, aluminum nitride, and the like. As a related prior art, there is disclosed a film-shaped adhesive using a highly thermally conductive filler having a thermal conductivity of 5.0 W/(m·K) or more (see JP-A-5-117621). JP-A-5-117621 discloses ceramics including alumina, diamond, etc., as specific examples of the highly thermally conductive filler.

Meanwhile, metal fillers such as copper, silver, iron, aluminum, and nickel show higher thermal conductivity than that of the above ceramics fillers. As a related prior art, there are disclosed a thermally conductive resin sheet containing a thermally conductive filler (see JP-A-2002-128931), a heat-radiating film containing metal or an inorganic filler (see JP-A-2002-371192), and a thermally conductive member provided with a sheet layer using metal powder and having a predetermined thermal conductivity (see JP-A-2003-243587). Incidentally, in JP-A-2002-371192, an organic filler, a metal filler, etc., are mentioned as specific examples of the thermally conductive filler.

However, generally, a metal filler having electric conductivity cannot be employed for a thermally conductive sheet used for electric or electronic appliances. This is because it is highly likely that the use of a metal filler causes detachment of the metal filler out of the end face of the sheet, which is prone to cause a problem such as a short circuit of an electric circuit.

It is known that a value of a thermal conductivity of metal fillers is one figure higher than that of ceramics fillers. Therefore, if only impartment of high thermal conductivity to a thermally conductive composition is taken into consideration, it is more effective to use a metal filler than to use a ceramic filler as a thermally conductive filler. However, as described above, there arises a problem that a thermally conductive sheet using a thermally conductive composition using a metal filler is not suitable as a thermally conductive sheet for electric or electronic appliances.

### SUMMARY

The present invention has been made in consideration of the conventional problems, aiming to provide a thermally conductive composition capable of giving a thermally conductive sheet which has high thermal conductivity, which may not cause a problem such as a short circuit even if it is disposed in an integrated circuit (IC), or the like, and which has superior reliability.

The present inventors made an energetic study to address the above object and, as a result, found out that the above problems can be addressed by adding a thermally conductive filler in which an oxide layer showing electrical insulation is formed on a surface of metal aluminum to an appropriate binder component, which led to the achievement of the present invention.

That is, according to the present invention, there is provided a thermally conductive composition shown below.

There is provided a thermally conductive composition comprising:
a thermally conductive filler, and
a binder component

wherein said thermally conductive filler comprises:
a particulate central portion comprising metal aluminum, and
an electrically-insulated oxide layer having an average thickness of 500 nm or more formed on a surface of said central portion.

It is also preferable that the central portion has an average particle diameter of 1 to 200 μm.

It is also preferable that the binder composition is a silicone resin, a (meth)acrylic resin, an urethane resin, or an epoxy resin.

It is also preferable that the composition further comprises at least one selected from the group consisting of ceramics, metal oxides, and metal hydrates.

In a thermally conductive composition of the present invention, a thermally conductive filler contained in the composition includes a particulate central portion of metal aluminum and an electrically-insulated oxide layer having an average thickness of 500 nm or more formed on a surface of the central portion. Therefore, the thermally conductive composition has high thermal conductivity, which does not cause a disadvantage such as a short circuit even if it is disposed in an integrated circuit (IC), or the like, and which has an effect in being capable of giving a thermally conductive sheet having superior reliability.

### DETAILED DESCRIPTION

The present invention is hereinbelow described with regard to preferred embodiments of the present invention. However, the present invention should not be limited to the following embodiments and may suitably be modified or improved on the basis of those skilled in the art within the range not deviating from the gist of the present invention.

An embodiment of the thermally conductive composition of the present invention is a thermally conductive composition containing a thermally conductive filler and a binder component. The thermally conductive filler includes a particulate central portion of metal aluminum and an electrically-insulated oxide layer having an average thickness of 500 nm or more formed on a surface of the central portion. The details are described below.

(1) Thermally Conductive Filler

The thermally conductive filler contained as an essential component in a thermally conductive composition of the present embodiment is a filler having a dual-layer structure with a particulate central portion of metal aluminum and an electrically-insulated oxide layer formed on a surface of the central portion. The central portion of the thermally conductive filler is constituted by metal aluminum having high thermal conductivity in comparison with ceramics or the like. Therefore, a thermally conductive composition of the present embodiment shows high thermal conductivity in comparison with the case of using a ceramic filler as a thermally conductive filler.

In addition, an electrically-insulated oxide layer having an average thickness of 500 nm or more is formed on the surface of the central portion of the thermally conductive filler used in the present embodiment. For example, suppose that a thermally conductive sheet produced by molding a thermally conductive composition of the present embodiment into the shape of a sheet is disposed near an electric circuit. In this case, even in the case that a part of the thermally conductive filler falls off from the end face of the thermally conductive sheet, the electric circuit may not cause a problem of short circuit. Therefore, a thermally conductive composition of the present embodiment is suitable as a material constituting a thermally conductive sheet to be disposed in an integrated circuit (IC), or the like, and has very high reliability.

In a thermally conductive composition of the present embodiment, the oxide layer of the thermally conductive filler contained in the thermally conductive composition preferably has an average thickness of 700 nm or more, more preferably 900 nm or more. When the oxide layer has an average thickness of less than 500 nm, the thermally conductive filler does not always exhibit sufficient electrically-insulating ability. Incidentally, there is no upper limitation on the average thickness of the oxide layer. However, it is preferably 3000 nm or less from the viewpoint of not extremely inhibiting thermal conductivity in the central portion.

The central portion of metal aluminum preferably has an average particle diameter of 1 to 200 μm, more preferably 1 to 100 μm, particularly preferably 1 to 80 μm. When the central portion has an average particle diameter of less than 1 μm, sometimes sufficient thermal conductivity is not exhibited because the diameter is too small. On the other hand, when the central portion has an average particle diameter of more than 200 μm, it tends to be difficult to incorporate the filler in the thermally conductive composition. Incidentally, “average particle diameter” in the present specification means: the average of the diameters when the particles are sphere, the average of each average value of the longer diameter and the shorter diameter of each particle when the particles are elliptic sphere, the average of each average value of the longest length and the shortest length of each particle when the particles have irregular shapes.

In the thermally conductive filler, it is preferred that a group of relatively large particles having the average particle diameter of 10 to 200 μm and a group of relatively small particles having the average particle diameter of below 10 μm are used in combination so as to increase the amount of the thermally conductive filler to be added to the material. It is further preferable to use a thermally conductive filler subjected to a surface treatment with silane, titanate, fatty acid, or the like so as to enhance internal strength of a thermally conductive sheet obtained by molding the thermally conductive composition.

The content of the thermally conductive filler in the whole thermally conductive composition of the present embodiment is preferably 5 to 90% by volume, more preferably 20 to 80% by volume. When the content is less than 5% by volume, the resultant thermally conductive composition has low thermal conductivity and tends to exhibit insufficient thermal conductivity. On the other hand, when the content is more than 90% by volume, the resultant thermally conductive sheet obtained by molding the thermally conductive composition tends to have insufficient internal strength and flexibility.

A thermally conductive filler contained in the thermally conductive composition of the present embodiment can be produced by subjecting metal aluminum particles to a predetermined treatment so as to form an oxide layer thereon. The oxide layer can be formed by subjecting metal aluminum particles to at least one treatment selected from the group consisting of an acid treatment, an energy beam irradiating treatment, an electrochemical treatment, and a thermal treatment. Incidentally, an oxide layer having a certain extent of thickness can be formed even by simply leaving metal aluminum particles in the air. However, it is preferred to employ any of the above treatments because a thickness of the oxide layer can be adjusted at will. In addition, according to any of the above treatments, it is expected that an oxide layer having superior electrically insulating ability can be formed to the case of simply leaving metal aluminum particles in the air.

The “acid treatment” means, for example, a treatment of putting metal aluminum particles in an organic or inorganic acid solution, or the like, having an appropriate concentration, and mixing and stirring them. The “energy beam irradiating treatment” means, for example, a treatment of irradiating ultraviolet ray to surfaces of metal aluminum particles with a high-pressure mercury lamp. The “electrochemical treatment” means, for example, a treatment of subjecting metal aluminum particles to anodic oxidation. The “thermal treatment” means, for example, a treatment of putting metal aluminum particles in an oven at 400 to 600° C. and leaving them for an appropriate period of time in air or oxygen atmosphere.

(2) Binder Component

The binder component contained as an essential component in the thermally conductive composition of the present embodiment may be a general polymer and is not particularly limited. However, it is preferable that the binder component is a silicone resin, a (meth)acrylic resin, an urethane resin, or an epoxy resin. When these resins are used as a binder component, the composition can easily be molded to give a member or molded article such as a thermally conductive sheet, a thermally conductive adhesive tape, or a thermally conductive bonding agent, and superior thermal conductivity of a thermally conductive composition of the present embodiment can be effectively utilized.

(3) Other Additives

It is preferable that a thermally conductive composition of the present invention further contains at least one selected from the group consisting of ceramics, metal oxides, and metal hydrate as a thermally conductive filler (the second thermally conductive filler) besides the aforementioned thermally conductive filler so as to enhance thermal conductivity of the resultant thermally conductive composition and a member or a molded article such as a thermally conductive sheet using the thermally conductive composition.

In the second thermally conductive filler, it is preferred that a group of relatively large particles having the average particle diameter of 10 to 200 μm and a group of relatively small particles having the average particle diameter of below 10 μm are used in combination so as to increase the amount of the second thermally conductive filler to be added to the material. It is further preferable to use the second thermally conductive filler which is subjected to a surface treatment with silane, titanate, fatty acid, or the like so as to enhance internal strength of a thermally conductive sheet obtained by molding the thermally conductive composition.

Various kinds of additives may be added to the thermally conductive composition of the present embodiment as long as the characteristics of the thermally conductive sheet are not spoiled. Examples of the additive include: crosslinking agents, tackifiers, antioxidants, chain-transfer agents, plasticizers, flame retardants, flame retarding synergists, precipitation inhibitors, thickeners, thixotropic agents such as ultra-fine silica powder, surfactants, antifoamers, colorants, electrically conductive particles, antistatic agents, and surface-treating agents. Incidentally, one or a combination of these additives may be used.

When a flame retardant is added to the composition, it is preferred to use a flame retardant which is substantially free from halogen (hereinbelow referred to as “halogen-free flame retardant”). Examples of the halogen-free flame retardant include: organic phosphorus compounds, expansible graphite, poly(phenylene ether), and triazine skeleton-containing compounds. Among these, organic phosphorous compounds are most preferable from the viewpoint of exhibition of flame retardant effect. Incidentally, one or a combination of these flame retardants may be used.

The organic phosphorous compound may be a copolymerizable or uncopolymerizable with the monomer constituting the binder component. When the binder component is a (meth)acrylic resin, examples of the organic phosphorous compound copolymerizable with (meth)acrylic monomers constituting the (meth)acrylic resin include phosphate-containing (meth)acrylic monomers.

Examples of the phosphate-containing (meth)acrylic monomers include: dimethyl((meth)acryloyloxymethyl)phosphate, diethyl((meth)acryloyloxymethyl)phosphate, diphenyl((meth)acryloyloxymethyl)phosphate, dimethyl(2-(meth)acryloyloxyethyl)phosphate, diethyl(2-(meth)acryloyloxyethyl)phosphate, diphenyl(2-(meth)acryloyloxyethyl)phosphate, dimethyl(3-(meth)acryloyloxypropyl)phosphate, diethyl(3-(meth)acryloyloxypropyl)phosphate, and diphenyl(3-(meth)acryloyloxypropyl)phosphate.

These phosphate containing (meth)acrylic monomers may be used singly or in combination of two or more kinds.

The content of the phosphate-containing (meth)acrylic monomer in the thermally conductive sheet of the present embodiment is preferably 1 to 30 parts by weight, more preferably 5 to 20 parts by weight, with respect to 100 parts by weight of monomer constituting the binder component. When the content is less than 1 parts by weight, flame retardant effect is sometimes deteriorated. When the content is more than 30 parts by weight, the resultant thermally conductive sheet sometimes has lowered flexibility.

Examples of organic phosphorous compound uncopolymerizable with monomers constituting the binder component include: phosphate esters, aromatic condensed phosphates, and ammonium polyphosphates.

Examples of the phosphate esters include: triphenyl phosphate, tricresyl phosphate, cresyl diphenyl phosphate, 2-ethylhexyl diphenyl phosphate, tri-n-butyl phosphate, trixylenyl phosphate, resorcinol bis(diphenyl phosphate), and bisphenol A bis(diphenyl phosphate). Examples of the ammonium polyphosphates include: ammonium polyphosphate, melamine modified ammonium polyphosphate, and coated ammonium polyphosphate. Incidentally, coated ammonium polyphosphate means ammonium polyphosphate which is resin-coated or micro-encapsulated to enhance water resisting property.

The content of the organic phosphate compound substantially uncopolymerizable with monomer constituting the binder component in the thermally conductive sheet of the present embodiment is preferably 5 to 50 parts by weight, more preferably 10 to 30 parts by weight, with respect to 100 parts by weight of monomer constituting the binder component. When the content is less than 5 parts by weight, flame retardant effect is sometimes deteriorated. When the content is more than 50 parts by weight, the resultant thermally conductive sheet has lowered cohesion or sometimes shows a bleeding phenomenon.

### EXAMPLE

The present invention is hereinbelow described specifically on the basis of Examples. However, the present invention is by no means limited to the Examples.

200 g of metal aluminum particles (commercial name: VA-200 produced by Yamaishimetals Co., Ltd.; average particle diameter: 50 μm) was mixed with 200 g of 30 wt % nitric acid aqueous solution, and the mixture was stirred for 15 minutes, followed by washing the mixture several times with ion-exchanged water. Then, the mixture was dried in an oven at 100° C. to obtain an acid-treated substance. The acid-treated substance was subjected to a thermal treatment for 30 minutes in an oven at 400° C. to obtain a thermally conductive filler. Incidentally, with regard to the thermally conductive filler obtained, the etching time by ESCA performed in accordance with the “method of surface analysis of a thermally conductive filler” described below was 250 minutes, and the oxide layer had a thickness of about 970 nm. Hereinbelow, the method of surface analysis of a thermally conductive filer (method for measuring the thickness of the oxide layer) is described.

Method of Surface Analysis of Thermally Conductive Filler

Compositional analysis of the thermally conductive filler obtained above was performed in a direction of the depth of the filler by ESCA (Electron Spectroscopy for Chemical Analysis). Specifically, the thermally conductive filler obtained was densely spread over a double-sided adhesive tape to prepare a sample. The sample was subjected to a compositional analysis in a direction of the depth at an etching speed of 38.7 Å/min (in terms of SiO₂) with respect to an analyzed area of 100 μm² using ESCA (commercial name: AXIS ULTRA produced by Kratos Analytical). From the strength of Al(2p) peak and at O(1 s) peak, the compositional ratio of aluminum atoms and oxygen atoms was calculated, and an etching time when the compositional ratio of aluminum atoms and oxygen atoms became 90% or more was measured. The compositional analysis was assumed to be complete at the etching time measured, and the etched depth was calculated as a thickness of the oxide layer.

0.04 parts by weight of an ultraviolet polymerization initiator (commercial name: Irgacure 651 produced by Ciba Specialty Chemicals K.K.) was mixed with 100 parts by weight of 2-ethylhexyl acrylate to give a mixture, ultraviolet ray was irradiated to the mixture to obtain a partial polymer having a kinematic viscosity of about 0.01 m²/s.

The partial polymer obtained above and the components shown in Table 1 were put into a mixer with each parts by weight shown in Table 1. The whole amount of the components shown in Table 1 was determined as 17 parts by weight, and a thermally conductive composition and alumina with each parts by weight shown in Table 2 were put into the mixer. The material in the mixer was deaerated and kneaded to obtain a thermally conductive composition (Example 1). The thermally conductive composition obtained was held by two liners, and the composition was subjected to calendering. After the calendering, the composition was heated for 15 minutes at 140° C. for a thermal polymerization reaction, and a thermally conductive sheet having a thickness of 1 mm was produced.

### Comparative Example 1

A thermally conductive composition was obtained in the same manner as in Example 1 except that an untreated metal aluminum particles (commercial name: VA-200 produced by Yamaishimetals Co., Ltd.) was employed in place of the thermally conductive filler (metal aluminum particles subjected to an acid treatment and a thermal treatment to form an oxide layer thereon). In addition, a thermally conductive sheet having a thickness of 1 mm was produced in the same manner as in Example 1. Incidentally, with regard to an untreated metal aluminum particles, the etching time by ESCA performed in accordance with “a method of surface analysis of a thermally conductive filler” was 30 minutes, and the oxide layer has a thickness of about 120 nm.

Each of the thermally conductive sheets obtained above was measured for thermal conductivity. The results are shown in Table 2. Incidentally, the method for measuring thermal conductivity is shown below.

Thermal Conductivity

The thermal conductivity was measured using a thermal conductivity measuring apparatus (commercial name: QTM-D3 by Kyoto Electronics Manufacturing Co., Ltd.).

TABLE 1

| Component | Parts by weight |
|---|---|
| Partial polymer | 10 |
| 2-ethylhexyl acrylate | 90 |
| hexanedioldiacrylate | 0.17 |
| Irganox 1076*¹ (antioxidant) | 0.3 |
| S-151*² (titanate-based coupling agent) | 3.0 |
| bis(4-t-butylcyclohexyl)peroxydicarbonate | 0.05 |
| 1,1-bis(t-hexylperoxy)3,3,5-trimethylcyclohexane | 0.80 |

*1: Commercial name (produced by Ciba Specialty Chemicals K.K.)
*2: Commercial name (produced by Nippon Soda Co., Ltd.)

TABLE 2

| | | Comp. |
|---|---|---|
| Component (parts by weight) | Ex. 1 | Ex. 1 |
| Binder component | 17 | 17 |
| Thermally conductive filler (aluminum particles | 56 | — |
| subjected to surface oxidation treatment) | | |
| Metal aluminum particle (no surface treatment) | — | 56 |
| Alumina (average particle diameter: 1.6 μm) | 27 | 27 |
| Thermal conductivity (W/(m · K)) | 4.2 | 3.7 |

As shown in Table 2, it was found that a thermally conductive sheet manufactured using a thermally conductive composition of Example 1 shows high thermal conductivity equivalent to that of the thermally conductive sheet manufactured using a thermally conductive composition of Comparative Example 1.

A thermally conductive composition of the present invention is suitable as a material constituting a thermally conductive sheet disposed between a radiating body such as a heat sink and a heat-generating part for electronics or electronic parts including an integrated circuit (IC).

What is claimed is:

1. A thermally conductive composition comprising:
a thermally conductive filler, and
a binder component
wherein said thermally conductive filler comprises:
a particulate central portion comprising metal aluminum, and
an electrically-insulated oxide layer having an average thickness of 500 nm or more formed on a surface of said central portion.

2. A thermally conductive composition according to claim 1, wherein the central portion has an average particle diameter of 1 to 200 μm.

3. A thermally conductive composition according to claim 1, wherein said binder composition is a silicone resin, a (meth)acrylic resin, an urethane resin, or an epoxy resin.

4. A thermally conductive composition according to claim 1, wherein said composition further comprises at least one selected from the group consisting of ceramics, metal oxides, and metal hydrates.
